(19) United States
(12) Patent Application Publication
(10) Pub. No.: US 2006/0224462 A1
(43) Pub. Date: Oct. 5, 2006

(54) Automated jewelry exchange

(76) Inventor: Larry Brezenoff, Coconut Creek, FL (US)

Correspondence Address: MICHAEL J. BUCHENHORNER, ESQ;HOLLAND & KNIGHT, 701 BRICKELL AVENUE, MIAMI, FL, 33131, US

(21) Appl. No.: 11/092,156

(22) Filed: Mar. 29, 2005

(51) Int. Cl. G06Q 30/00

(52) U.S. Cl. 705/26

(57) ABSTRACT

An information processing system for facilitating jewelry transactions is disclosed. The information processing system includes a first interface for receiving from suppliers information relating to a plurality of items of jewelry available for purchase and components related to the items and a database configured for storing the information relating to the items and related components. The information processing system further includes a second interface for presenting to buyers the information relating to the plurality of items of jewelry and for receiving from buyers a selection of an item for purchase and a search engine for searching the database for information relating to an item of jewelry and related components. The information processing system further includes logic for presenting to the buyer information associated with components related to an item of jewelry and options on constructing a jewelry assembly comprising the item and components selected by the buyer.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of electronic commerce and more particularly relates to the field of electronic commerce in jewelry.

### BACKGROUND OF THE INVENTION

With the advent of mass networked communication, such as the World Wide Web (hereinafter, “the web”), traditional channels of distribution have been changing substantially in all industries, including the jewelry industry. Consumers, retail stores, wholesalers and manufactures are sourcing products in new and novel ways. The Internet and other resources for communicating, displaying and transacting in products and services have made it clear that almost anyone can make his or her products and services available to anyone that has access to the Internet and email. Wal-Mart, for example, had a similar idea when it reached out to rural markets and developed a wide range of supplier relationships to bring a diverse selection and ease of shopping to its customers. Manufacturers do not generally understand what buyers want or need; they typically want to sell what they make and cannot respond to what the customer wants to buy. For the most part, traditional channels have relied on wholesalers to work with multiple manufactures to meet buyers' needs. Wholesalers in turn bring to retailers a selection of products, and the retailers re-merchandise and sell to the consumer.

This phenomena is especially true in the jewelry industry. There is a multiple tier system wherein wholesalers relay to manufacturers the needs and desires of consumers and buyers. However, there is no mechanism whereby consumers or buyers can design their own products based on available parts. This problem is further compounded by the lack of an extensive and user-friendly jewelry exchange system.

Therefore, a need exists to overcome the problems with the prior art as discussed above, and particularly for an automated jewelry exchange system with a jewelry design feature.

### SUMMARY OF THE INVENTION

Briefly, according to an embodiment of the present invention, an information processing system for facilitating jewelry transactions includes a first interface for receiving from suppliers information relating to a plurality of items of jewelry available for purchase and components related to the plurality of items and a database configured for storing the information relating to the plurality of items and the components related to the plurality of items. The information processing system further includes a second interface for presenting to buyers the information relating to the plurality of items of jewelry and for receiving from buyers a selection of an item of jewelry for purchase and a search engine for searching the database for information relating to an item of jewelry selected by a buyer and components related to the item of jewelry. The information processing system further includes logic for presenting to the buyer, via the second interface, information associated with components related to an item of jewelry selected by the buyer and options on constructing a jewelry assembly comprising the item of jewelry and components selected by the buyer via the second interface.

In another embodiment of the present invention, a method for facilitating jewelry transactions includes receiving from suppliers, via a first interface, information relating to a plurality of items of jewelry available for purchase and components related to the plurality of items and storing in a database the information relating to the plurality of items and the components related to the plurality of items. The method further includes presenting to buyers, via a second interface, the information relating to the plurality of items of jewelry and for receiving from buyers a selection of an item of jewelry for purchase and searching the database for information relating to an item of jewelry selected by a buyer and components related to the item of jewelry. The method further includes presenting to the buyer, via the second interface, information associated with components related to an item of jewelry selected by the buyer and options on constructing a jewelry assembly comprising the item of jewelry and components selected by the buyer via the second interface.

In another embodiment of the present invention, a computer readable medium including computer instructions for facilitating jewelry transactions includes instructions for receiving from suppliers, via a first interface, information relating to a plurality of items of jewelry available for purchase and components related to the plurality of items and storing in a database the information relating to the plurality of items and the components related to the plurality of items. The computer instructions further include instructions for presenting to buyers, via a second interface, the information relating to the plurality of items of jewelry and for receiving from buyers a selection of an item of jewelry for purchase and searching the database for information relating to an item of jewelry selected by a buyer and components related to the item of jewelry. The computer instructions further include instructions for presenting to the buyer, via the second interface, information associated with components related to an item of jewelry selected by the buyer and options on constructing a jewelry assembly comprising the item of jewelry and components selected by the buyer via the second interface.

### BRIEF DESCRIPTION OF THE DRAWINGS

FIG. 1 is block diagram showing a high-level network architecture of one embodiment of the present invention.

FIG. 2 is a block diagram showing modules used in conjunction with a central processor in one embodiment of the present invention.

FIG. 3 is a flowchart showing the control flow of the order creation process in one embodiment of the present invention.

FIG. 4 is a flowchart showing the control flow of the post-order process in one embodiment of the present invention.

FIGS. 5-9 are screenshots of interfaces used by suppliers to provide product information, in one embodiment of the present invention.

FIGS. 10-14 are screenshots of interfaces used by buyers to view, select, construct and purchase products, in one embodiment of the present invention.

FIG. 15 is a high level block diagram showing an information processing system useful for implementing one embodiment of the present invention.

### DETAILED DESCRIPTION

The present invention provides an exchange or marketplace wherein buyers, entities that buy wholesale quantities of jewelry for resale, seek and purchase products, i.e., items of jewelry, and wherein sellers or suppliers, entities that provide wholesale quantities of jewelry for purchase, list and describe products for sale. The present invention handles the jewelry supply chain and allows for the filtering of product details in a user friendly graphical user interface. The present invention provides a business-to-business market for a specific industry—the jewelry manufacturing and exchange industry.

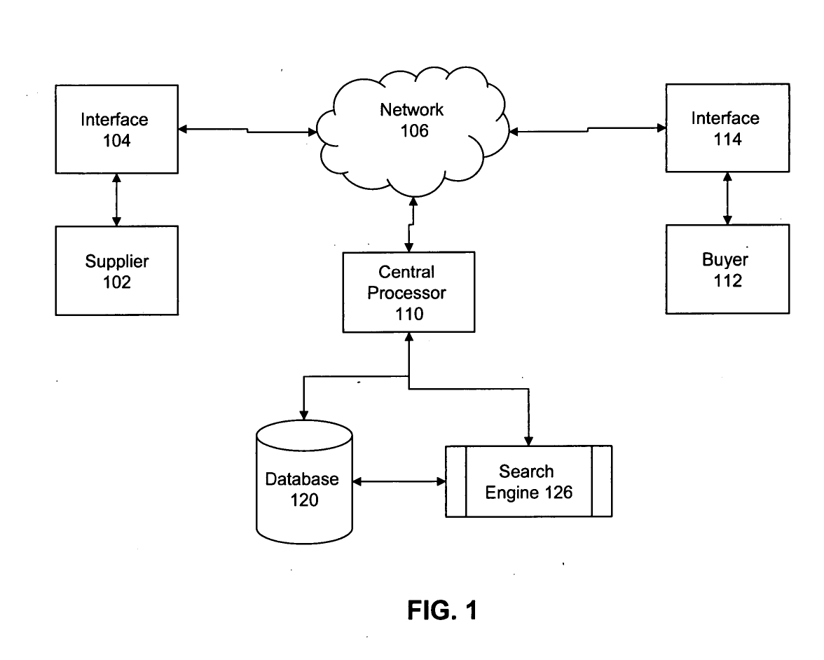

FIG. 1 is block diagram showing a high-level network architecture of one embodiment of the present invention. FIG. 1 shows an interface 104 and an interface 114 connected to a network 106. FIG. 1 also shows a database 120 and search engine 126, both of which are connected to a central processor 110, which is connected to the network 106. A supplier 102, which provides wholesale quantities of jewelry for purchase, interacts with interface 104 while a buyer 112, which buys wholesale quantities of jewelry for resale, interacts with interface 114.

Central processor 110 regulates access to database 120 and the search engine 126. The present invention may also include a database management system (not shown) that manages the database 120. The central processor 110 interacts with interfaces 104 and 114 to provide the information displayed in the interfaces and receive information that is entered into the interfaces. The central processor 110 may also provide standalone applications and/or plug-in applications that execute within interfaces or in conjunction with interfaces 104 and 114.

Interfaces 104 and 114 can be applications, components of a larger application, computers running applications or any other information processing systems capable of presenting an information interface such as a graphical user interface, a command line interface or an electronic data interchange interface. In one embodiment of the present invention, interfaces 104 and 114 can be web browsers, web applications or other applications that connect and communicate via the Web. In another embodiment of the present invention, interfaces 104 and 114 can be independent applications that transmit and receive data via the Web. In yet another embodiment of the present invention, interfaces 104 and 114 can comprise any commercially available computing system that can be programmed to offer the functions of the present invention. In yet another embodiment of the present invention, interfaces 104 and 114 can be a client computer running a client application that interacts with central processor 110 as a client computer in a client-server relationship.

In an embodiment where interfaces 104 and 114 are applications or components of applications, interfaces 104 and 114 can be implemented as hardware, software or any combination of the two. The applications or components of applications can be located in a distributed fashion. In this embodiment, the applications or components of applications can operate in a distributed computing paradigm.

Likewise, central processor 110 can be applications, components of a larger application, computers running applications or any other information processing systems. In one embodiment of the present invention, central processor 110 can comprise any commercially available computing system that can be programmed to offer the functions of the present invention. In yet another embodiment of the present invention, central processor 110 can be a client computer running a server application that interacts with interfaces 104 and 114 as a server computer in a client-server relationship.

In an embodiment where central processor 110 comprises applications or components of applications, central processor 110 can be implemented as hardware, software or any combination of the two. The applications or components of applications can be located in a distributed fashion. In this embodiment, the applications or components of applications can operate in a distributed computing paradigm.

In an embodiment of the present invention, the computer systems of central processor 110 and interfaces 104 and 114 are one or more Personal Computers (PCs) (e.g., IBM or compatible PC workstations running the Microsoft Windows operating system, Macintosh computers running the Mac OS operating system, or equivalent), Personal Digital Assistants (PDAs), laptop computer, hand held computers, palm top computers, smart phones, game consoles or any other information processing devices. In another embodiment, the computer systems of central processor 110 and interfaces 104 and 114 are a server system (e.g., SUN Ultra workstations running the SunOS operating system or IBM RS/6000 workstations and servers running the AIX operating system). The computer systems of central processor 110 and interfaces 104 and 114 are described in greater detail below with reference to FIG. 30.

In an embodiment of the present invention, the network 106 is a circuit switched network, such as the Public Switched Telephone Network (PSTN). In another embodiment, the network 106 is a packet switched network. The packet switched network is a wide area network (WAN), such as the global Internet, a private WAN, a local area network (LAN), a telecommunications network or any combination of the above-mentioned networks. In yet another embodiment, the network 106 is a wired network, a wireless network, a broadcast network or a point-to-point network.

It should be noted that although central processor 110, database 120, search engine 126 and interfaces 104 and 114 are shown as separate entities in FIG. 1, some or all of the functions of these entities may be integrated into one entity or more entities. It should also be noted that although FIG. 1 shows only two interfaces, the present invention supports any number of interfaces. Likewise, the present invention supports any number of suppliers and buyers.

Generally, the present invention allows a supplier 102 to provide, via interface 104, information relating to a plurality of items of jewelry available for purchase and components related to the plurality of items. The information provided by the supplier 102 is stored in a database configured for storing the information relating to the plurality of items and the components related to the plurality of items. A second interface 114 allows buyers 112 to view the information relating to the plurality of items of jewelry allows buyers 112 to select an item of jewelry for purchase. The search engine 126 searches the database 120 for information relating to an item of jewelry selected by a buyer and components related to the item of jewelry. Logic, residing in central processor 110, presents to the buyer 112, via the second interface 114, information associated with components related to an item of jewelry selected by the buyer 112 and options on constructing a jewelry assembly comprising the item of jewelry and components selected by the buyer 112.

An item of jewelry can include a necklace, a ring, an earring, a pendant, a bracelet and a watch. Other items of jewelry include loose stones, loose gems, pieces of valuable metals, a broach, body piercing jewelry, or any other type of jewelry. A component related to an item of jewelry can include at least one of a setting, a stone, and a side stone. Other components can include loose stones, loose gems and pieces of valuable metals. A component comprises one or more attributes. Attributes of a setting include a metal and a setting type. Attributes of a stone and a side stone include shape, color, cut, clarity, gridles, labs, culets, polish symmetry, fluorescent intensity, enhancements, markings, and luster.

In one embodiment of the present invention, a third interface is provided for receiving payment information from the buyer 112 for purchasing the item of jewelry selected by the buyer 112. In another embodiment of the present invention, the second interface 114 allows buyers 112 to enter search parameters relating to an item of jewelry for purchase and the search engine 126 searches the database 120 for an item of jewelry that matches the search parameters entered.

In yet another embodiment of the present invention, the central processor 110 includes logic for determining, based on dimensions of the item of jewelry selected by the buyer 112, components that fit the item of jewelry selected by the buyer 112 and presenting to the buyer 112, via the second interface 114, information associated with the components that fit the item of jewelry selected by the buyer 112 and options on constructing a jewelry assembly comprising the item of jewelry and components selected by the buyer 112.

For example, a buyer 112 may choose a particular setting having particular dimensions of the opening for placing a stone. The central processor 110 includes logic for reading the particular dimensions of the opening from the database 120. Based on the particular dimensions of the opening of the setting, the central processor 110 includes logic for searching for and identifying stones having dimensions that fit the opening of the setting. The central processor 110 reads the particular dimensions of stones from the database 120 and identifies stones having dimensions that fit the opening of the setting. These stones are presented to the buyer 112, via the second interface 114, as components that fit the item of jewelry selected by the buyer 112 (the setting). These stones are also presented as options on constructing a jewelry assembly comprising the setting and the components presented.

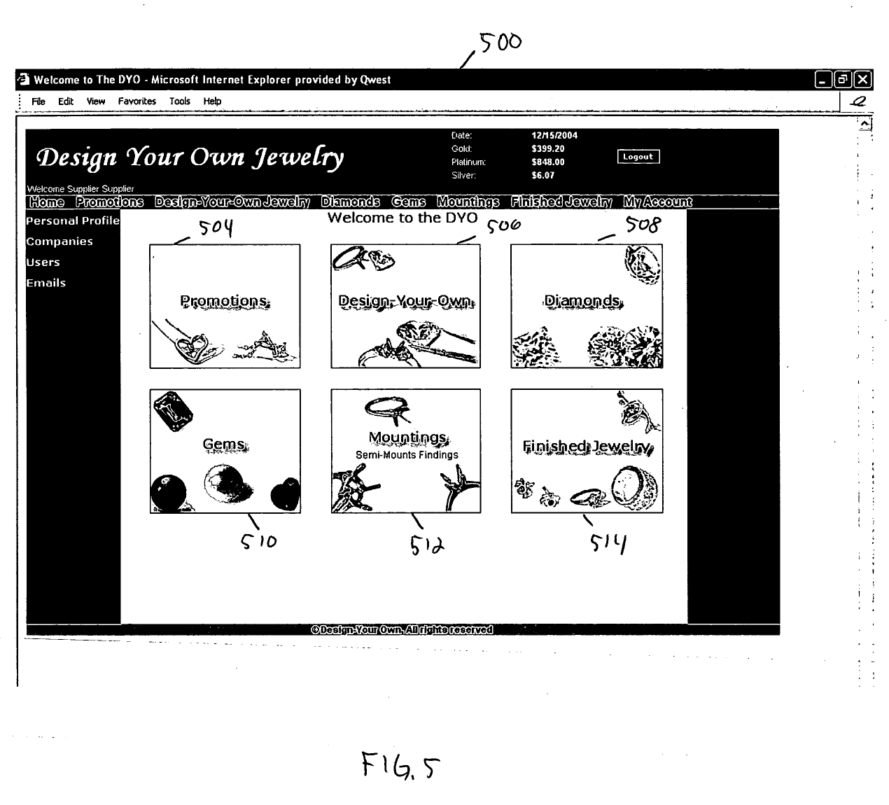

The following provides an overview of the functions performed by the present invention. The present invention creates a platform for suppliers 102 to list products, i.e., items of jewelry, via the interface 104, which specifically addresses the needs of suppliers 102 in the jewelry industry. FIGS. 5-9 are screenshots of interfaces used by suppliers to provide product information, in one embodiment of the present invention.

FIG. 5 is a web-based graphical user interface presented via a web browser interface 500. The interface 500 presents a supplier 102 with a list of options via buttons. Button 504 leads the supplier to a web page for viewing current promotions, button 506 leads the supplier to a web page for designing jewelry, button 508 leads the supplier to a web page for viewing diamonds in the current inventory, button 510 leads the supplier to a web page for viewing gems in the current inventory, button 512 leads the supplier to a web page for viewing mountings in the current inventory and button 514 leads the supplier to a web page for viewing finished jewelry in the current inventory.

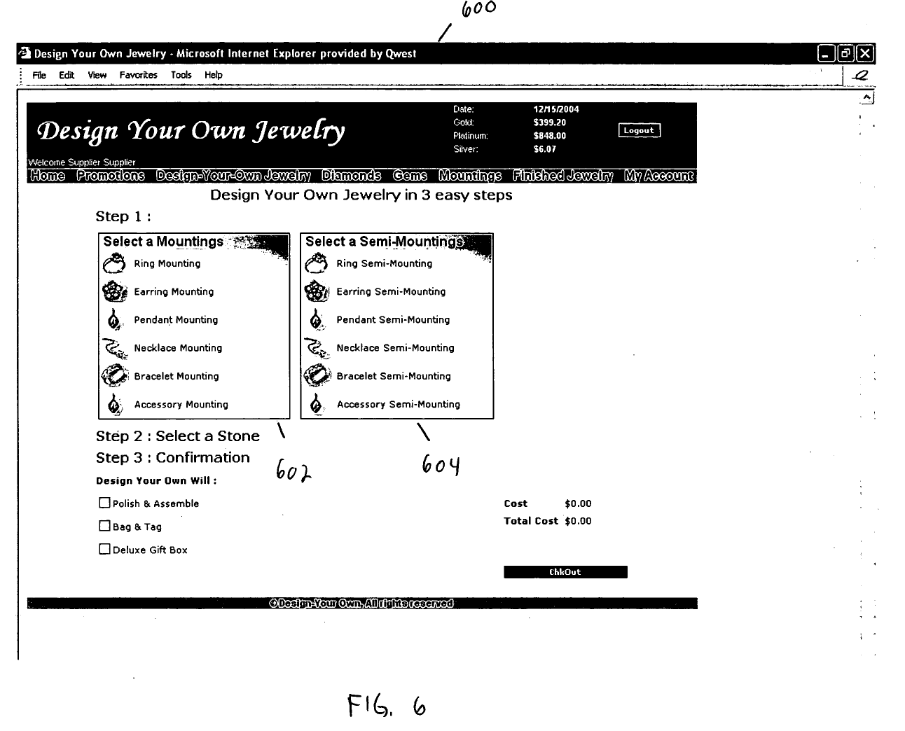

FIG. 6 is a web-based graphical user interface presented via a web browser interface 600. The interface 600 is presented to a supplier when selecting the button 506 of interface 500. The interface 600 presents a supplier 102 with a list of options for designing jewelry. The drop down menu 602 allows the supplier to choose from a list of mountings. The drop down menu 604 allows the supplier to choose from a list of semi-mountings.

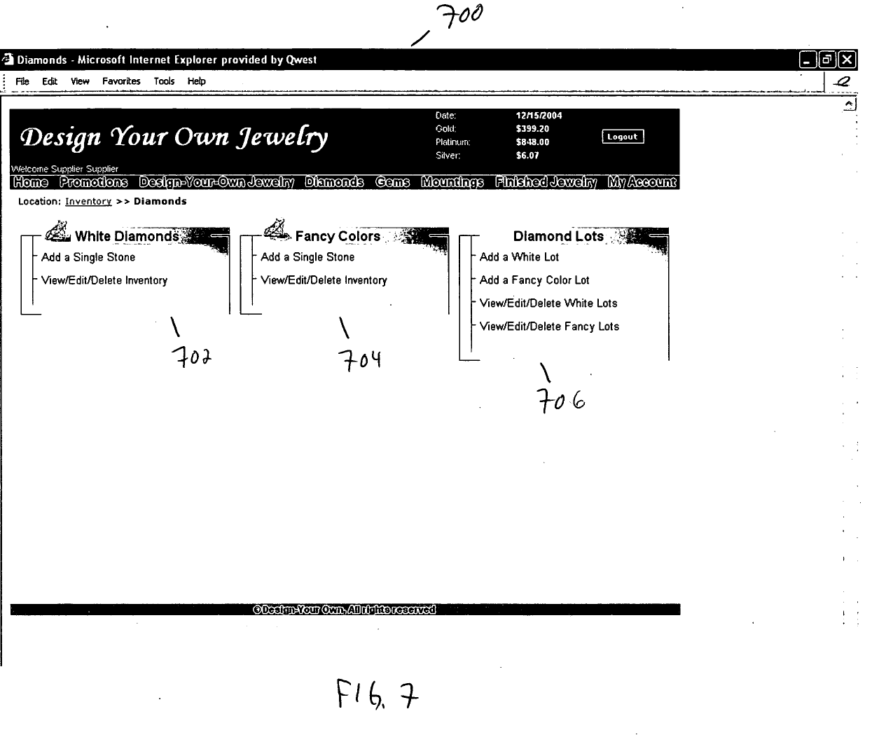

FIG. 7 is a web-based graphical user interface presented via a web browser interface 700. The interface 700 is presented to a supplier during the process of designing jewelry, after selecting the button 506 of interface 500. The interface 700 presents a supplier 102 with a list of options for designing jewelry. The drop down menu 702 allows the supplier to choose from a list of white diamonds. The drop down menu 704 allows the supplier to choose from a list of fancy colors. The drop down menu 706 allows the supplier to choose from a list of diamond lots.

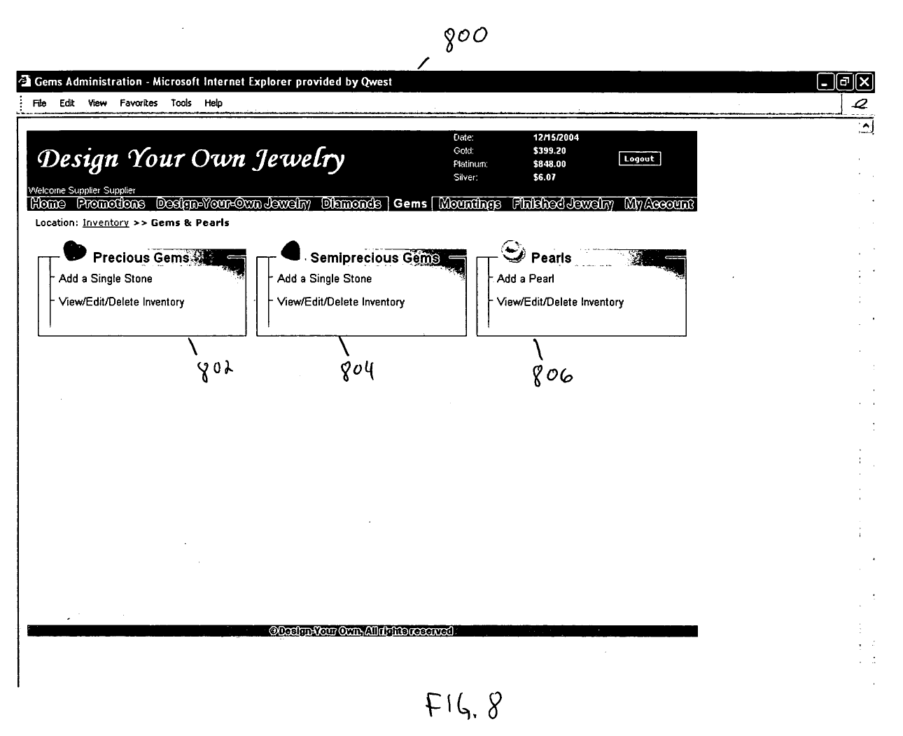

FIG. 8 is a web-based graphical user interface presented via a web browser interface 800. The interface 800 is presented to a supplier during the process of designing jewelry, after selecting the button 506 of interface 500. The interface 800 presents a supplier 102 with a list of options for designing jewelry. The drop down menu 802 allows the supplier to choose from a list of precious gems. The drop down menu 804 allows the supplier to choose from a list of semi-precious gems. The drop down menu 806 allows the supplier to choose from a list of pearls.

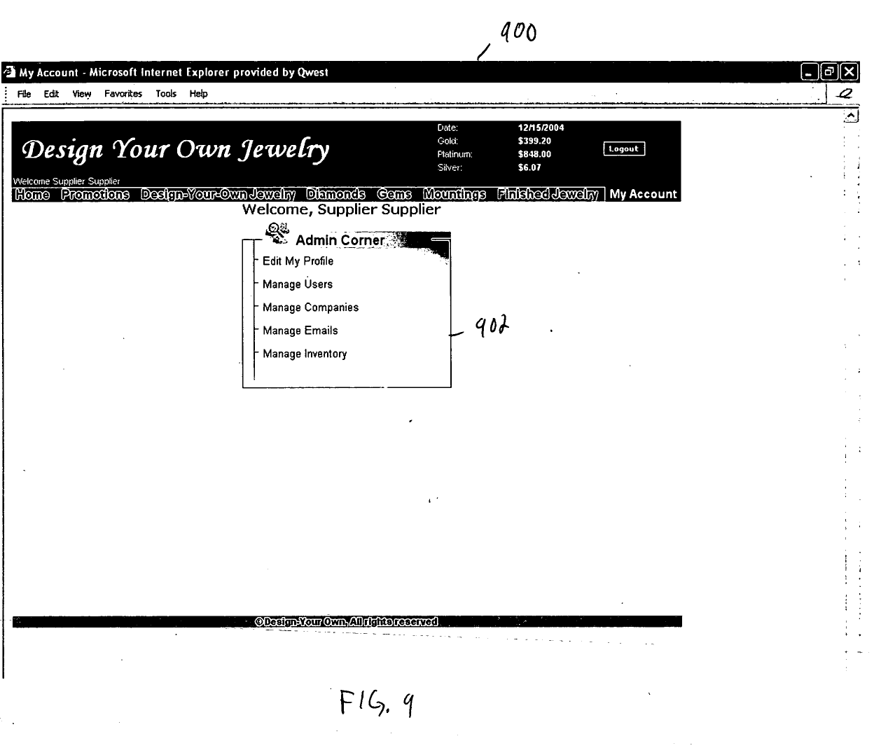

FIG. 9 is a web-based graphical user interface presented via a web browser interface 900. The interface 900 presents a supplier 102 with a list of options for administrating usage of his account. The drop down menu 902 allows the supplier to choose from a list of list of actions that allow the supplier to edit its profile, manage users, manage companies, etc.

FIGS. 5-9 show examples of web-based graphical user interfaces that can be used by suppliers 102 to enter information into the database 120. Interface 104, for example, provides tools that allow suppliers 102 to upload and download bulk information electronically to/from database 120. Therefore, the present invention provides an inexpensive and user-friendly mechanism for suppliers 102 to list products for purchase. The present invention can also hide any information associated with a supplier, such as supplier identifying information, when information is displayed to a buyer 112 via interface 114.

The present invention further provides a platform that handles order processing information, communication about orders and distribution of orders. Notification and communication of orders from buyers 112 to sellers 102 are conducted by the present invention. Further, the present invention conducts order processing and grouping of orders to the same suppliers 102 to facilitate order fulfillment.

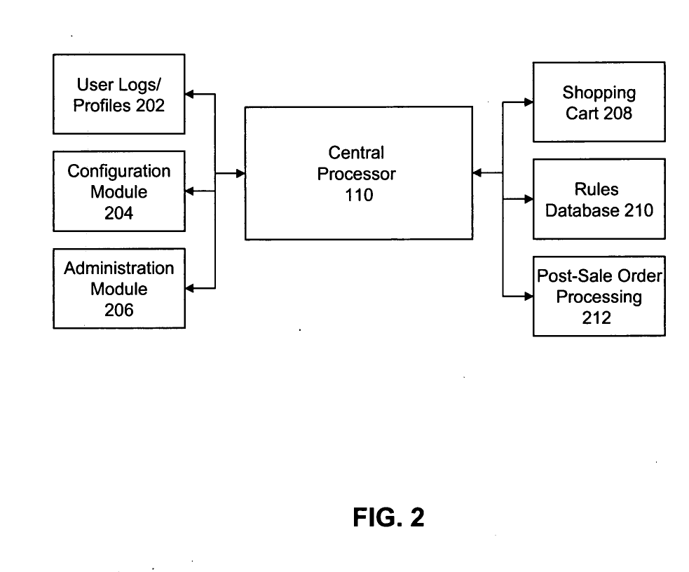

Additionally, a payment process is provided, allowing for buyers 112 to provide payments for ordered items to suppliers 102. The payment process can occur directly between suppliers 102 and buyers 112, or may be conducted via an intermediary such as central processor 110. A buyer 112 can provide a payment via an established account held by the central processor 110, such as a deposit account from which funds are subtracted when products are purchased. Thus, credit can be provided via an account for positive balances. The order and payment processes are described in greater detail below with reference to FIG. 2. Further, the present invention can provide a system whereby buyers 112 can provide feedback to suppliers 102 regarding a purchase, the product bought, or any other aspects of the buyer's experience.

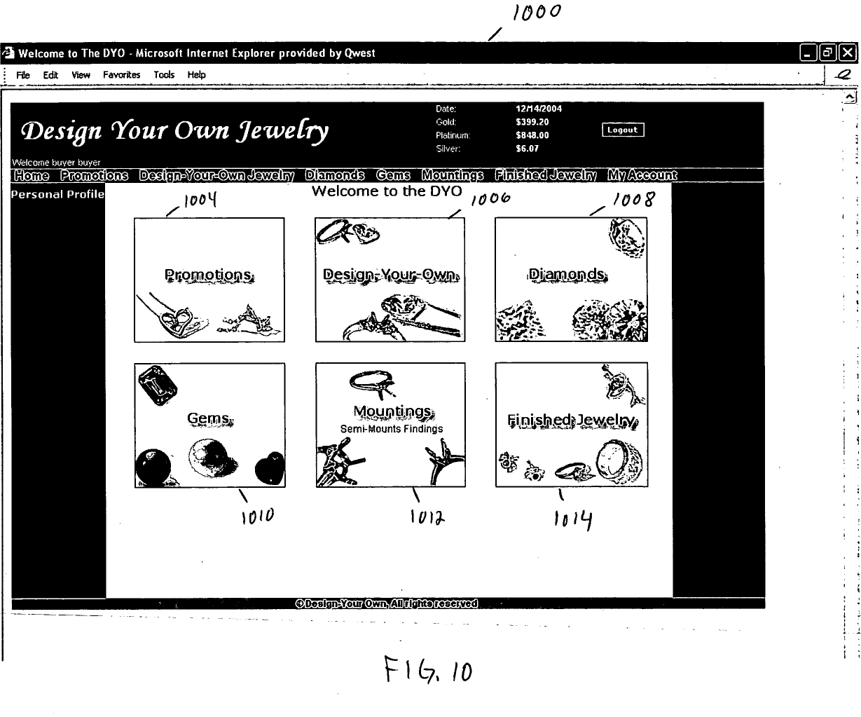

The present invention further provides an inexpensive and user-friendly platform for buyers 112 to search for, construct, select and purchase items of jewelry and components listed for purchase by suppliers 102. FIGS. 10-14 are screenshots of interfaces used by buyers to view, select, construct and purchase products, in one embodiment of the present invention.

FIG. 10 is a web-based graphical user interface presented via a web browser interface 1000. The interface 1000 presents a buyer with a list of options via buttons. Button 1004 leads the buyer to a web page for viewing current promotions, button 1006 leads the buyer to a web page for designing jewelry, button 1008 leads the buyer to a web page for viewing diamonds in the current inventory, button 1010 leads the buyer to a web page for viewing gems in the current inventory, button 1012 leads the buyer to a web page for viewing mountings in the current inventory and button 1014 leads the buyer to a web page for viewing finished jewelry in the current inventory.

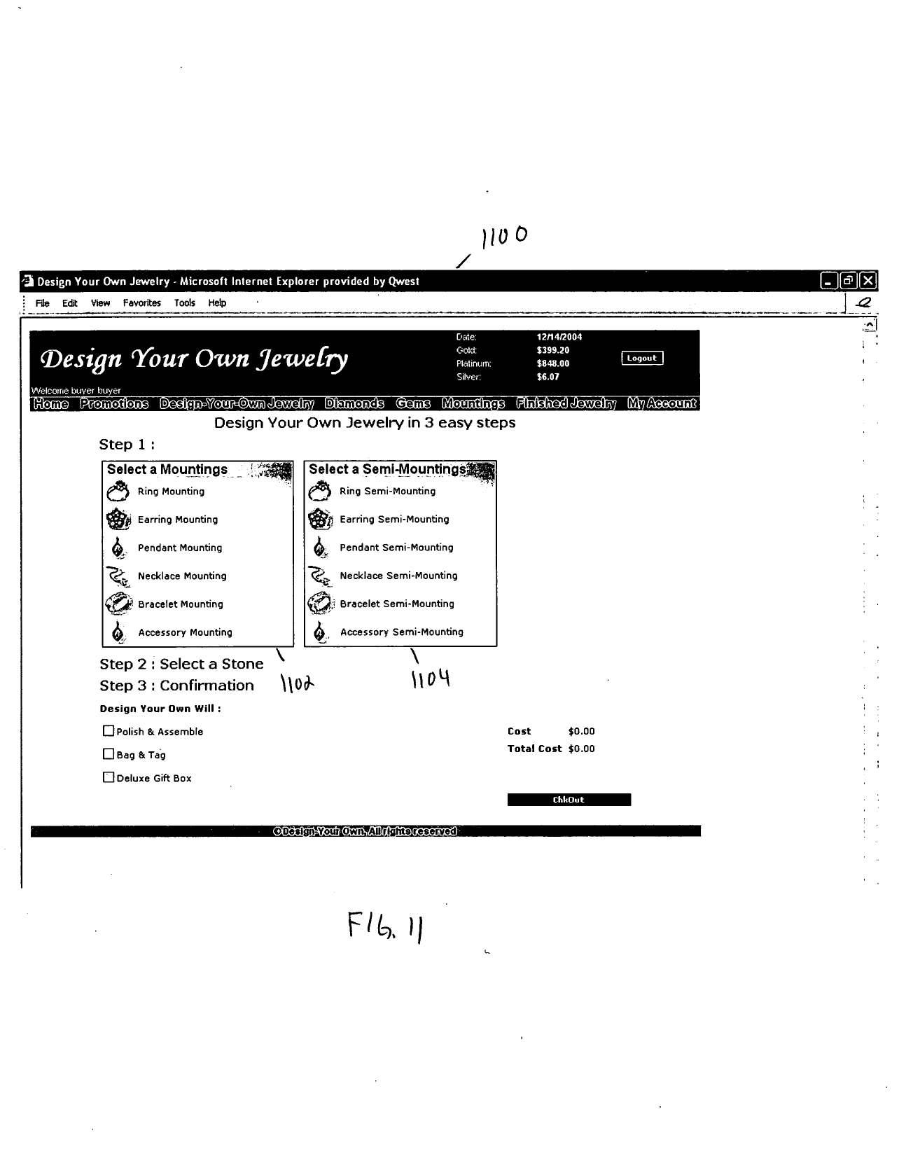

FIG. 11 is a web-based graphical user interface presented via a web browser interface 1100. The interface 1100 is presented to a supplier when selecting the button 1006 of interface 1000. The interface 1100 presents a buyer with a list of options for designing jewelry. The drop down menu 1102 allows the buyer to choose from a list of mountings. The drop down menu 1104 allows the buyer to choose from a list of semi-mountings.

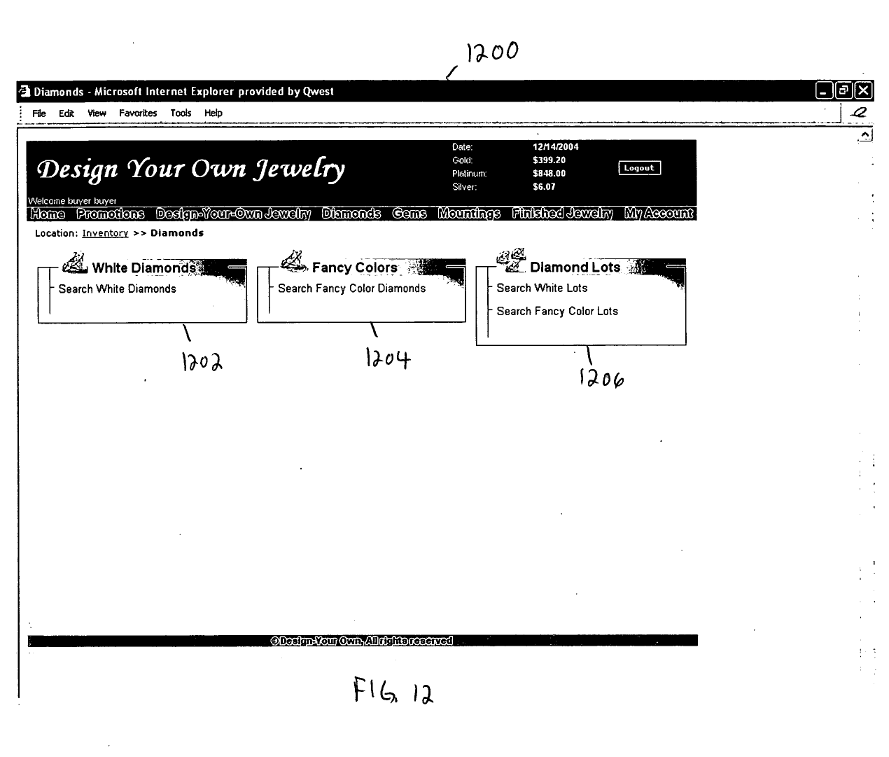

FIG. 12 is a web-based graphical user interface presented via a web browser interface 1200. The interface 1200 is presented to a buyer during the process of designing jewelry, after selecting the button 1006 of interface 1000. The interface 1200 presents a buyer with a list of options for designing jewelry. The drop down menu 1202 allows the buyer to choose from a list of white diamonds. The drop down menu 1204 allows the buyer to choose from a list of fancy colors. The drop down menu 1206 allows the buyer to choose from a list of diamond lots.

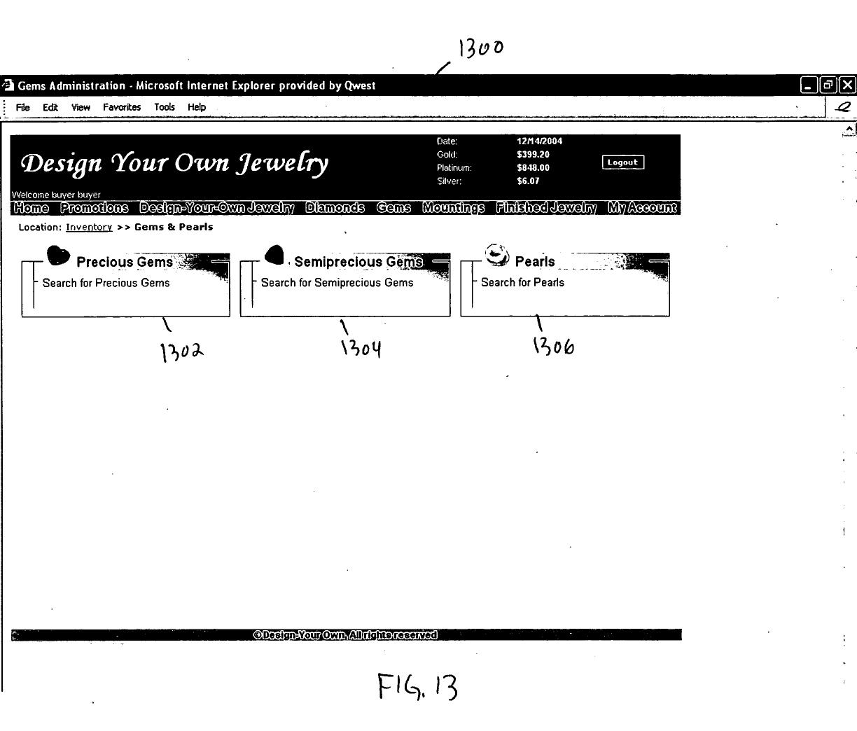

FIG. 13 is a web-based graphical user interface presented via a web browser interface 1300. The interface 1300 is presented to a buyer during the process of designing jewelry, after selecting the button 1006 of interface 1000. The interface 1300 presents a buyer with a list of options for designing jewelry. The drop down menu 1302 allows the buyer to choose from a list of precious gems. The drop down menu 1304 allows the buyer to choose from a list of semi-precious gems. The drop down menu 1306 allows the buyer to choose from a list of pearls.

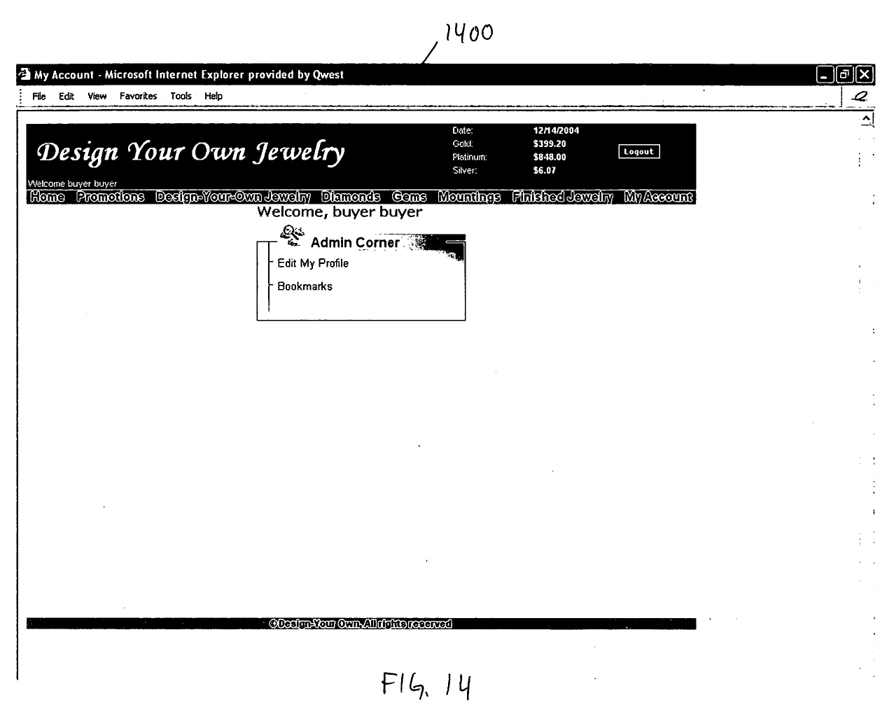

FIG. 14 is a web-based graphical user interface presented via a web browser interface 1400. The interface 1400 presents a buyer with a list of options for administrating usage of his account. The drop down menu 1402 allows the buyer to choose from a list of list of actions that allow the supplier to edit its profile, manage users, manage companies, etc.

FIGS. 10-14 show examples of web-based graphical user interfaces that can be used by buyers 112 to view and purchase items of jewelry. Interface 114, for example, provides tools that allow buyers 112 to view information electronically from database 120. Therefore, the present invention provides an inexpensive and user-friendly mechanism for buyers 112 to view and purchase products.

The present invention can further includes an image database that includes at least one image for every type of item of jewelry or components related to an item of jewelry. Such as database would allow buyers 112 to quickly and easily view an image relating to a desired item of jewelry, thereby facilitating the purchase process regardless of the supplier 102 offering the product for purchase. The image library allows for images to be resized for display on interfaces 104 and 114 and allows a user to toggle his view from a gallery view, which displays a group of images for one item, or a listing view, which displays all items that belong to a particular category. The present invention can further provide a mechanism that allows buyers 112 to select one or more products and compare prices for the selected (or similar) product(s) across all suppliers 102.

In another embodiment of the present invention, a listing fee can be charged to each supplier 102 listing a product or products. A flexible listing fee structure can be created for each supplier and/or account based on different factors such as volume, product groups or types. These listing fees can be used by the system administrators to defray the costs of running the system of the present invention. Further, the present invention allows for sales individuals, or brokers, who broker the sale of items of jewelry. Commissions can be provided to sales individuals who broker the sale of items. A flexible commission structure can be created for each sales individual and/or account based on different factors such as volume, product groups or types. In yet another embodiment of the present invention, an offer feature is presented whereby buyers 112 can make offers to buy products from suppliers 102, and suppliers 102 can make offers to sell products to buyers 112.

In another embodiment of the present invention, a dynamic search tool is provided. A search interface that interacts with search engine 126 allows for basic searches whereby a single or multiple keywords or tokens are searched, and allows for advanced searches whereby additional search parameters spanning multiple attributes can be provided for a search. Further, the search interface can change according to the type of item or product being searched, such that only relevant attributes or components are displayed. Additionally, the listing interface 114 for buyers 112 can change according to the type of items or products being viewed, such that only relevant attributes or components are displayed. Searches can be saved for later retrieval or viewing and searches can be scheduled for future times. Thus, the future availability of items can be known.

Moreover, the interface 104 for suppliers 102 can include a supplier pricing and quantity matrix whereby a chart showing prices on one axis and quantities on another axis are displayed. Further, the interface 104 for suppliers 102 can include a supplier delivery matrix whereby a chart showing delivery times on one axis and quantities or products on another axis are displayed. Also, the interface 104 can display supplier profile information, including contact information, billing information, sales information, product information, and the like.

FIG. 2 is a block diagram showing modules used in conjunction with a central processor in one embodiment of the present invention. FIG. 2 shows the central processor 110 and the ancillary modules of the present invention. FIG. 2 shows the user log/profile module 202, the configuration module 204, the administration module 206, a shopping cart module 208, a rules database 210 and a post-sale order processing module 212. The user log/profile module 202 regulates, stores and maintains all profile information for all users of the system, including buyers, 112, suppliers, 102, sales representatives, agents, administrators, etc. The user log/profile module 202 further can maintain a log of user activity. The administration module 206 provides an interface by which an administrator of the system of the present invention can interact with some or all of the processes and modules of the system to administer and otherwise maintain the system.

The shopping cart module 208 provides a mechanism by which users of the system can effectuate a purchase of an item by providing payment and beginning the delivery process. The post-sale order processing module 212 provides a mechanism by which orders for purchase of at least one item are forwarded to the relevant suppliers and subsequently fulfilled. The configuration module 204 allows a user to configure usage of his account or the accounts associated with his company or group. The rules database 210 provides a database of rules that are used for the classification, search and construction of jewelry and components of jewelry.

The following section provides more detail on the different types of users and their roles, in one embodiment of the present invention. In one embodiment of the present invention, a user of the system, such as buyers 112, suppliers 102 or other individuals or groups, can possess a user account comprising a user name or login identification and a password. These users can register to receive log-in credentials and thereby log into the system during use. A user profile can also be associated with a user. Users can be authorized to perform certain actions but not others. Examples of actions that may require authorization are: purchasing items on the system for trade pricing, listing inventory, making offers, placing items on hold, emailing a pricing request. Further, users can designate other users to represent their accounts. For example, a user can be assigned to an account and based on that user's roll, the user will be given additional rights based on that role.

The following section provides more detail on certain actions that may be performed by users, in one embodiment of the present invention. In one embodiment of the present invention, a user of the system can be provided with pre-calculated prices for items based on a metal market higher or less than current prices based on authorization level. Further, a user may be allowed to build products but may not be able to place an order until the user become registered. A credit card may be required to complete the transaction or have a form of payment, such as deposit account, on file. Users may or may not be able to create, schedule, or save searches based on their privileges and may or may not be able to re-calculate prices on item view to current market prices. Further, a user may be limited in the number of results viewed unless the user registers or logs on. Additionally, users may not be able to offer, hold or request pricing unless the user logs on or registers and is approved.

Users may further be allowed to update profile information, shipping and billing information, place credit cards or deposit accounts on file and setup preferences for operation, based on authorization levels. Certain users may also be allowed to purchase items at pre-calculated market prices and list items (components and completed products) at certain prices.

The following section provides more detail on certain actions that may be performed by buyers, in one embodiment of the present invention. Furthermore, certain users, such as certain buyers 112, may be allowed to save search parameters and set-up e-mail alerts to schedule and execute saved searches. Further, these users may place special requests for items not found in the database 120. Special requests are forwarded to the suppliers 102 that have listed themselves as interested in receiving special requests. These users can further place items on hold under the preconditions set by the supplier 102 for that item. Also, certain users, such as certain buyers 112, may be allowed to make an offer on all products when permitted by a supplier 102. The user can request a quote of price or quantity for all products if marked by the supplier 102 as such. Items may be priced by component or completed product. Item pricing can be recalculated for current or entered market price in the item view.

Certain users, such as certain buyers 112, may be allowed to check out and purchase selected items with a new credit card, a credit card on file and view the status of the order. The users may be allowed to setup and manage other sub-user's rights including passwords, ordering, access filters of account information and display multipliers. The users may also be allowed to enter and update ship-to addresses and credit card information and set display multipliers (i.e., the cost to the buyer plus the display multiplier equals display price).

The following section provides more detail on certain actions that may be performed by suppliers, in one embodiment of the present invention. Certain users, such as certain buyers 112, may be allowed to manage all their inventory, including adding and refreshing quantities of items in the inventory. These users may also be allowed to: input changes manually, upload and download information from a spreadsheet file, review inventory, activate or inactivate inventory, remove or re-list inventory, set settings such as default shipping time for the supplier and change shipping time per listing and quantity level, allow for price adjustments based on gold, platinum, and silver markets on the item listing and add incremental prices based on quantity. These users may further be allowed to: receive notice of offers, accept or decline offers received from other users, receive notice of requests for quotes, reply to quote requests, indicate product types to receive special order requests of items not in the database 120, receive notice of new orders, review and confirm orders, review open and closed offers and quote requests, print picking tickets and shipping labels, post and change status of orders from “pending” to “ship”, run account management reports, set acceptable forms of payment from the host of the system of the present invention, set default delivery methods, allow full shipping of an item or order, allow partial shipping of an item or order, setup and manage sub-user rights including passwords, ordering, access filters of account information and display multipliers.

The following section provides more detail on certain actions that may be performed by sales representatives, in one embodiment of the present invention. Certain users, such as sales representatives, or agents of buyers 112 or suppliers 102, may be given all of the privileges of a buyer 112 or a supplier 102 when approved. These users may also be authorized to: request to be assigned to a specific account, set pricing levels for their assigned accounts and view relevant commissions, set up initial required user information, user name and password once approved, manage inventory like a supplier when approved as a supplier 102, maintain and update special instructions folders, place a request for a quote on behalf of an account, receive duplicate notification of all transactions, view reports on orders and status for all relevant accounts, view reports on shipment in progress for all relevant accounts, view reports on sales history and commissions, view reports on direct outbound marketing materials of new items to relevant accounts, and view reports on export information to lead management software. These users may also be authorized to manage the ordering process by reviewing open orders, hold orders and shipped orders. Representatives can be given authorization to review and modify the contact or user information of any entity (buyer or supplier) that he represents.

The following section provides more detail on certain actions that may be performed by an administrator, in one embodiment of the present invention. As explained above, the administration module 206 provides an interface by which an administrator of the system of the present invention can interact with some or all of the processes and modules of the system to administer and otherwise maintain the system. An administrator may be authorized to: set up an entity's profile information and users, gain access to any information of a user, set up all mark-ups, commissions, etc., manage inventory like a supplier for all suppliers 102, view reports on all orders, shipments or other units, manage ordering process generally, review open orders, hold orders and shipped orders, enter receipt of orders and acceptance of orders, ship orders, track orders, enter receipt of an order with a bona fide form of payment, and manage the image library by creating types of product and subtypes, uploading pictures, setting sizes and setting defaults and watermarks.

The following section provides more detail on certain views and searches of items of jewelry, in one embodiment of the present invention. The present invention provides for varying types of views of information garnered from users and the database 120 of items of jewelry for purchase. Items of jewelry and/or related components include white diamonds, color diamonds, gems/pearls, semi-mounts, findings/castings, white diamond lots, colored diamond lots, and finished jewelry such as rings, earrings, pendants, necklaces, chains and bracelets. Each of the items of jewelry and/or related components described above can be searched using basic search or advanced search, as described above, and can be viewed using a list view or a gallery view.

The following section provides more detail on the display and calculation of prices, in one embodiment of the present invention. The present invention will display gold, silver and platinum market prices by, for example, polling web services that provide this information. Items and orders can be priced at current market prices at the time items are moved to a shopping cart. All costs are pre-calculated to a market range to reduce calculations during searches. A recalculate button is provided if a buyer desires to see a price prior to check out.

For each item of jewelry listed, a check box called “Price Mounting to Current Market” is provided. If this box is checked, the price of the mounting is adjusted to reflect the current market price of the metal comprising the mounting. This adjusted cost, plus a markup, is displayed as the cost of the item. The item cost, plus the display multiplier, is the display price. If the button is not checked then it is assumed that a re-calculation to current market when an item sells is not desired.

An administrator of the present invention can enter a markup percentage for each buyer 112 on individual products or groups of products. There can be a master markup percentage value based on preset profiles such as a wholesaler, retailer, mass merchant, etc. The markup percentage can be pre-populated at the time a user registers and the present invention can modify the markup percentage from buyer to buyer based on the profile of the user. The price of an item can then be adjusted by a percentage increase when displayed. For example if a supplier 102 lists an item for $100 and a buyer 112 mark-up is 20% then the item will be listed to the buyer 112 at a price of $120. Sales representatives can also set or change pricing on accounts for which he possesses authorization.

An administrator can enter a processing fee for each supplier 102. There can be a master setting, such as 3%, which represents a supplier processing fee. This fee may be changed from supplier to supplier based on certain factors such as volume. This processing fee can be deducted from an amount owed to the supplier for an item purchased by a buyer 112. For example, if an item is listed for $100 and the processing fee is 3%, then the supplier 102, upon the sale of the item, receives $97.

The following section provides more detail on the process of purchasing items of jewelry using a “buy” button, in one embodiment of the present invention. When a user of the present invention selects an item and desires to purchase it, he can press a button, such as a buy button. Subsequently, a second window opens, thereby allowing the user to see pricing for different quantities of the same item. In one embodiment, the user must be registered before getting current market pricing or being able to make an offer. Once registered, a user can be considered a buyer 112 but at the highest price for an item until given higher access, wherein the item would be offered at a price lower than the highest price.

A buyer can have the option to recalculate the price of the selected item at the current market price in the second window. The second window allows the buyer to select the quantity of the item desired. This moves the item or items to the shopping cart and the window re-calculates the price of the item or items for the current market and quantity. If the supplier 102 of the item has indicated that he will accept offers for the item, the buy button will appear as an offer button and the buyer 112 can offer an amount for a quantity and use a button, such as a submit button, to send the offer.

Thus, upon viewing an item, a user can proceed to a shopping cart and check out, can adjust quantities and update pricing before checking out, remove items before checking out, continue shopping or build/adjust selected items of jewelry before checking out. Further, the user can be provided with a related-items section suggested items or jewelry or components that compliment the item being purchased. The related-items section can be provided by the supplier 102 of the item being purchased. Initiating the checkout process displays a page to the user including the user's billing and shipping address and provides the user with an option to enter a new credit card, use a credit card on record or provide another form of payment. At checkout, the user can change the shipping address.

Any user of the present invention can complete a purchase if he is registered, i.e., possesses an account with the system of the present invention. In one embodiment of the present invention, a user that is authorized for trade pricing can purchase items at a price that is below full list price. Also, if a supplier has indicated a preference for receiving an email for a price quote at certain quantities, the supplier's listed items will be displayed with a button, such as a “Ask for Quote Button,” whereby a buyer can request a price quote from the supplier for a selected item.

The following section provides more detail on the process of holding items of jewelry using a “hold” button, in one embodiment of the present invention. When a user of the present invention selects an item and desires to hold it for future purchase, he can press a button, such as a hold button. Subsequently, a second window opens, thereby allowing the user to indicate how long the user would like to place the item on hold. The supplier of the item has the option of allowing the item to be held using this process. In addition, the supplier can indicate limits on the hold time allowed.

The following section provides more detail on the process of making offers to buy items of jewelry using an “offer” button, in one embodiment of the present invention. When a user of the present invention selects an item and desires to make an offer to purchase the item, he can press a button, such as an offer button. Subsequently, a second window opens, thereby allowing the user to indicate the amount of the offer. The supplier of the item has the option of allowing offers to made on the item. In addition, the supplier can indicate limits on offers made for the item. When making an offer, a buyer can indicate the quantity of the item, the price per unit, and credit card information for effectuating the sale.

An offer can be sent to the suppler (wherein the offer is adjusted with any markups) via email indicating that the supplier can accept or reject the offer. If the offer is accepted, then the credit card information selected is charged and the sale is effectuated. A notification, such as an email, is sent to the buyer for both accepted and rejected offers. Such notifications and offers are formatted to protect buyer and supplier identities. Buyers and suppliers can be warned that offers are good for a certain period of time and expire afterwards.

The following section provides more detail on the process of building or constructing items of jewelry for purchase, in one embodiment of the present invention. When a user of the present invention selects an item and desires to build or construct an item of jewelry, he can press a button, such as a build button. Subsequently, a second window opens, thereby allowing the user to indicate specifications for building an item of jewelry. For example, a user can select an item such as a diamond, gem, or mounting and press build button. This initiates a series of steps for building a jewelry item. If a diamond or a gem is selected, then a list of mountings that fit the diamond or gem is displayed. This list is narrowed by selecting the following: a ring, an earring, a pendant, or a semi-mount.

Once a mounting is selected, the user must select an opening, or, if only one opening is selected, the user selects a gem type such as a diamond or gem. Once a diamond or gem is selected, then the interface displays only the diamonds or gems that fit the setting/semi-mount opening selected. Subsequently, basic or advanced searches can be selected to narrow further choices. Under each gem or diamond listed, an “add” button is provided for adding the stone to the item being built. Once a stone is added, a full screen is displayed showing the selected mounting and the selected gems by opening, and the user may either add a gem to an opening or remove/change a gem for the opening. At any point, the buyer may press a buy button and the selected/constructed item(s) are displayed in a checkout page. Constructed or built items are grouped by an order number (assigned upon entering checkout).

The following section provides more detail on a buyer shipment tracking process, in one embodiment of the present invention. A buyer can log into the system of the present invention and check on the status of an order. Since an order can be shipped partially or in full, the buyer can view each individual item ordered and its shipping status.

The following section provides more detail on the post-order process, in one embodiment of the present invention. When an order is complete and payment is authorized, the post order processing system activates. An order can have a status of “new” indicating a new order. When an order takes this status, an email is sent to the supplier that an order has been placed. When viewing this order, a buyer will see that the status is shown as “In-Process From Supplier.” An order can have a status of “in process” indicating that an order is being processed. An order can be deemed “in process” by a supplier when he beings the order fulfillment process. When viewing this order, a buyer will see that the status is shown as “In-Process From Supplier.” When reviewing an order, a supplier can provide the following info: expected shipping date and notes to the system administrator. When reviewing an order, a system administrator can provide the following info: expected shipping date (adjusted for additional delay) and notes to the buyer.

An order can further have a status of “supplier shipped” indicating that an order has been shipped by the supplier. When viewing this order, a buyer will see that the status is shown as “In-Process From Supplier.” When reviewing such an order, a supplier can indicate the quantity of an item shipped. The default will be a list of all items purchased and all quantities requested, but supplier may modify this default and make a partial shipment. Partial shipment spawns two tickets or processes (a shipped ticket and in-process ticket). In one embodiment, a postal or courier system tracking number can be garnered from the postal or courier system utilized. Further, the status of the shipment can be garnered from the postal or courier system utilized.

An order can further have a status of “supplier hold” indicating that an order has been held by the supplier if a problem has been encountered. When reviewing such an order, a supplier can include a note to the buyer, an expected shipping date, a note to the exchange of the present invention, or a shipping date from the exchange. When viewing this order, a buyer will see that the status is shown as “Supplier Hold.” A buyer may have the authorization to cancel such an order.

An order can further have a status of.“received by exchange” indicating that an order has been received by the exchange of the present invention. When reviewing such an order, an administrator of the exchange of the present invention can include a date received. When viewing this order, a buyer will see that the status is shown as “In Process by Exchange” indicating that an order is in process by the exchange of the present invention.

An order can further have a status of “inspected by exchange” indicating that an order has been inspected by the exchange of the present invention. When reviewing such an order, an administrator of the exchange of the present invention can include whether the contents of the order package is accurate, the number of items missing if it is not accurate, the creation of a separate ticket or process if not accurate and the sending of an email to the supplier. When viewing this order, a buyer will see that the status is shown as “In Process by Exchange.” After the exchange has reviewed the order, processed it and verified it, the order can then be shipped off to the buyer.

An order can further have a status of “shipped by exchange” indicating that an order has been shipped by the exchange of the present invention. When viewing this order, a buyer will see that the status is shown as “Shipped to Buyer.”

The following section provides more detail on a tool for administrators of the exchange of the present invention for adding users to the system, in one embodiment of the present invention. Administrators can add users to the system or add companies or groups and later add users to those companies or groups. Once a user is created, the user is sent an email and the user must complete an application and agree to the terms of an agreement. A user can set his own user identification and password. A user can have a preferred payment method listed, such as a credit card on file, paying by check or using a credit card with each purchase. A user can also have the following information associated with his account: billing and shipping address, a display multiplier, a markup for the exchange system, a processing fee, and contact information. It should be noted that any company, corporation or business association can be a buyer or supplier. A user is one of possible many members of a company, corporation or business association. A company, corporation or business association can be both a supplier or buyer. Users that are a member of a company can be designated as a buyer or supplier or both, by the administrator or head user of that company.

An administrator can activate or deactivate a user or an entire company/group, which will deactivate all of its related users. If a user or company/group is reactivated, all user names and passwords revert to their original states before deactivation. An administrator can further set default views (gallery or list), number of results to display, display multipliers, preferred market to display. An administrator can further set defaults for the post-order process, such as defining how and when to email suppliers, details on printing pick tickets and shipping labels and details on creating and sending notifications of orders.

The following section provides more detail on activities that can be performed by users that have not logged in or that do not have a user account, in one embodiment of the present invention. These users can perform basic and advanced searches, as well as view items in a gallery view or list view. Prices, however, may be displayed at a higher than normal price, such as three times the fully marked up price. These users may be limited to the number of pages that may be viewed and may be prompted to register. Further, these users may not be able to purchase items but may do so after registering or opening an account.

The following section provides more detail on activities that can be performed by a buyer 112, in one embodiment of the present invention. A buyer 112 can define and/or manage the rights or authorizations of other users in its company or group. These authorizations include purchasing with a credit card on file, purchasing with a personal credit card, displaying items at a predefined markup. Buyers may also save search criteria, review pending and closed offers, view pricing requests, review pending and shipped orders, set personal defaults such as views (gallery or list), numbers of results per page, and displaying multipliers. Buyers may further search for items by either list or gallery view, view lowest and highest prices of items in either view and view lowest and highest quantities of items in either view. Buyers may also have the ability to have their previously viewed pages tagged or stored for later recall, sort items by heading in list view, sort items by drop down lists in ascending or descending order in gallery view, and define simple fields and detail fields for advance searches. Buyers can further view precious and semi-precious gems.

The following section provides more detail on activities that can be performed by a supplier 102, in one embodiment of the present invention. A supplier 102 can perform all of the same actions as a buyer and may have all of the rights and authorizations of a buyer but may additionally manage inventory, assign finished jewelry to categories, base prices on markets for certain commodities and define increments of change for those prices, define whether or not offers are accepted for certain products, upload data via a spreadsheet program, duplicate items from existing items, make items active or inactive and add pictures to items or use default pictures from category and item description. Suppliers may further receive a list of pending and closed offers, receive a list of pending and closed requests, and receive a list of pending, shipped and paid orders.

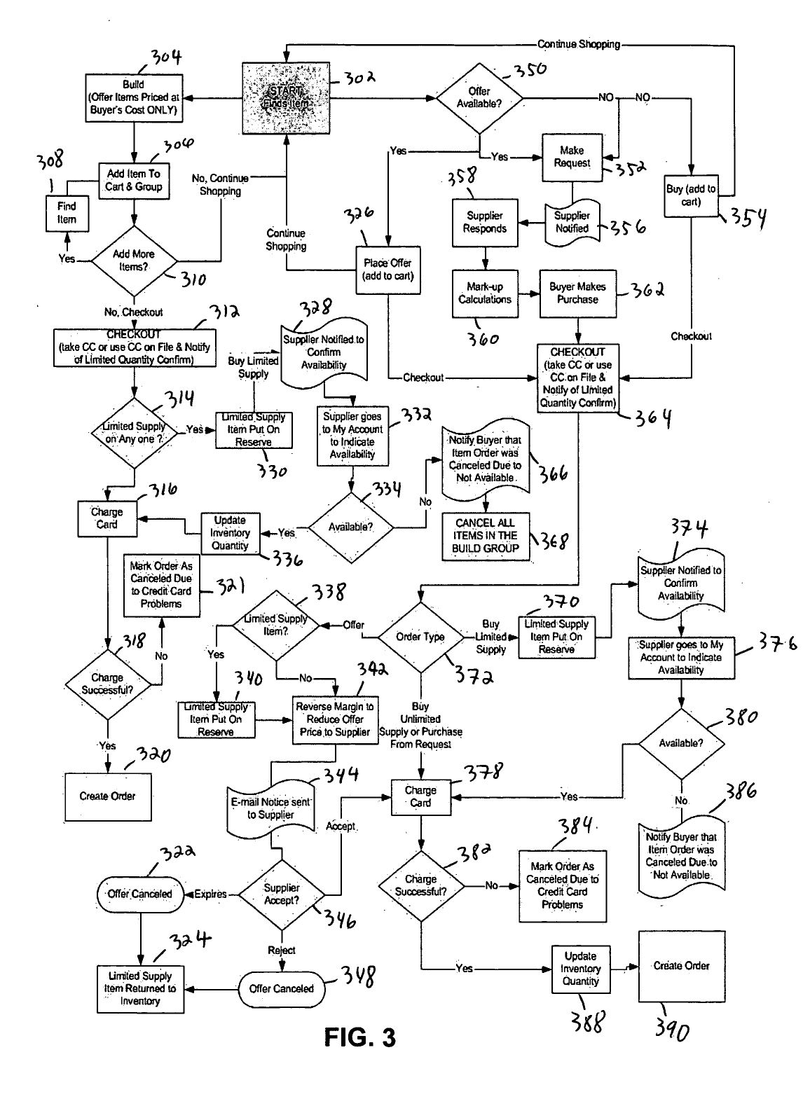

FIG. 3 is a flowchart showing the control flow of the order creation process in one embodiment of the present invention. FIG. 3 shows one example in which a user can created an order for an item or items of jewelry using the system of the present invention. The control flow begins with step 302 where a user, such as a buyer, finds an item of jewelry. If the user chooses to build an item of jewelry, the building process is executed in step 304. Next, in step 306, the item of jewelry is added to a shopping cart. In step 310 it is determined whether the user desires to add more items. If the user decides to add more items, then the user goes on to find and add more items in step 308. If the user decides to check out, then in step 312, the user checks out and the processing system uses the user's credit card information (whether provided by the user contemporaneously or accessed from credit card information on file) to initiate the buying process. If the user decides to continue shopping, the control flow returns to step 302.

In step 314 it is determined whether there is a limited supply of any of the items selected by the user for purchase. If there is a limited supply of any of the items selected by the user for purchase, then in step 330 the limited supply item is placed on reserve and in step 328 the supplier is notified to confirm availability of the limited supply item when it becomes available. Next, in step 332, the supplier indicates the availability of the item in step 332. In step 334, if the supplier indicates that the limited supply item is available, then the quantity of the limited supply item is updates in the inventory in step 336 and in step 316 the user's credit card is charged for the item. In step 334, if the supplier indicates that the limited supply item is not available, then the buyer is notified that the limited supply item was cancelled due to unavailability in step 366 and in step 368 all of the items in the build group (i.e., the group of components that comprise the limited supply item of jewelry) are cancelled.

In step 318 it is determined whether the charge to the credit card was successful. If the charge was successful, then in step 320, the order for the items selected by the user is created. If the charge was not successful, then in step 320, the order for the items selected by the user is cancelled due to a problem charging to the credit card.

Returning to step 302 where a user, such as a buyer, finds an item of jewelry, if the ability to make an offer is available or not available for the selected item of jewelry in step 350, the user makes a request to make an offer in step 352. In step 356, the supplier is notified of the request and in step 358 the supplier responds to the request. In step 360 the mark up calculations of price are executed and in step 362 the user makes the purchase. If the ability to make an offer is not available in step 350, the user can add the item to his shopping cart in step 354.

In step 364, the user checks out and the processing system uses the user's credit card information (whether provided by the user contemporaneously or accessed from credit card information on file) to initiate the buying process. In step 372 the type of order is determined. If the order was initiated as an offer then it is determined whether the item is a limited supply item in step 338. If the item is a limited supply item, then in step 340 the limited supply item is placed on reserve. If the item is not a limited supply item, then in step 342 the margin of the limited supply item is reversed to reduce the offer price to the supplier. In step 344 an email notice is sent to the supplier of the offer and in step 346 it is determined whether the supplier accepts the offer. If the supplier accepts the offer in step 378 the user's credit card is charged for the item. If the supplier rejects the offer in step 348 then in step 324 the limited supply item is returned to the inventory. If the offer expires then in step 322 the offer is cancelled and in step 324 the limited supply item is returned to the inventory.

If in step 372 the order was the purchase of a limited supply then in step 370 the limited supply item is placed on reserve. In step 374 the supplier is notified to confirm availability of the limited supply item when it becomes available. Next, in step 376, the supplier indicates the availability of the item. In step 380, if the supplier indicates that the limited supply item is available, then in step 378 the user's credit card is charged for the item. In step 386, if the supplier indicates that the limited supply item is not available, then the buyer is notified that the limited supply item was cancelled due to unavailability.

In step 382 it is determined whether the charge to the credit card of step 378 was successful. If the charge was successful, then in step 388 the quantity of the selected items of jewelry is updated in the inventory and an order is created in step 390. If the charge was not successful, then in step 384 the order is cancelled due to a problem charging the credit card of the user.

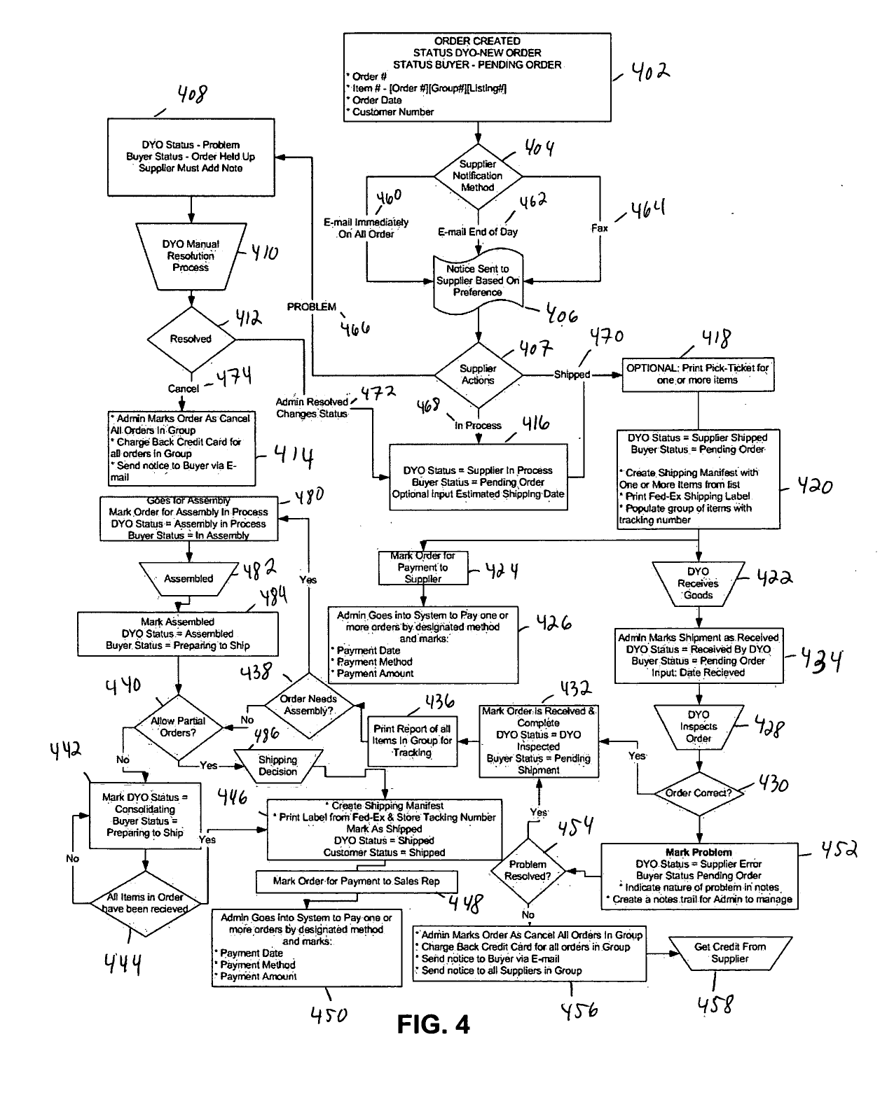

FIG. 4 is a flowchart showing the control flow of the post-order process in one embodiment of the present invention. FIG. 4 shows an example of post-processing an order for an item or items of jewelry using the system of the present invention. The control flow begins with step 402 where a user, such as a buyer, has placed an order an item or items of jewelry. Step 402 begins with the following information, garnered from step 390 in FIG. 3: order number or identifier, item number or identifier, order date and customer number or identifier. In step 404 it is determined which type of supplier notification to use. The supplier is either notified using email immediately in step 460, using email at the end of the day in step 462 or by fax in step 464. In step 406 the notice is sent to the supplier based on the preference of the supplier.

In step 407 it is determined which action is taken by the supplier handling the order. If the supplier encounters a problem with the order in step 466, then in step 408 the supplier marks the order status as a problem, the buyer is notified that the order is held up or delayed and the supplier is prompted to add a note providing more information about the status of the order. In step 410 a manual resolution process is initiated whereby a live operator or administrator is prompted to handle the problem encountered in step 466. In step 412 it is determined whether the problem encountered in step 466 was resolved. If the problem was resolved by an administrator in step 472, then the administrator changes the status of the order to “in process” and in step 416 the order proceeds. In step 416 the status of the order viewed by the buyer is changed to “pending order” and optionally an estimated shipping date is input into the system. Subsequent to step 416, the supplier ships the order in step 470.

Referring back to step 412, if the problem was not resolved, then the ordered is cancelled in step 474 and in step 414 an administrator marks the order and all of its dependant orders as cancelled, the credit card of the buyer is charged back any charges related to the cancelled order and a notice is sent to the buyer of the cancelled order via email.

Referring back to step 407, if the supplier processes the order in step 468, then in step 416 the status of the order viewed by the buyer is changed to “pending order” and optionally an estimated shipping date is input into the system. Again referring back to step 407, if the supplier ships the order in step 470, then in optional step 418 a pick ticket is printed for the item or items ordered. In step 420, the status of the order viewed by the buyer is changed to “pending order,” a shipping manifest is created with the one or more items that were ordered, an overnight courier shipping label can be printed and each item ordered can be associated with a courier tracking number.

In step 422 the system of the present invention receives the goods ordered and in step 434 an administrator marks the shipment as received, the status of the order is changed to “received,” the status or the order viewed by the buyer is changed to “pending order” and the date received information is associated with the order. Alternative to step 422, in step 424 the order may be marked for payment to the supplier. Next, in step 426, an administrator effectuates payment for the ordered goods and stores the payment date, payment method and payment amount.

In step 428, the administrator inspects the order and in step 430 it is determined whether the order is correct. If the order is correct, then in step 432 the order is marked as received and complete and the order is marked as inspected. The status of the order viewed by the buyer is changed to “pending shipment.” If the order is not correct, then in step 452 the order is marked as a problem order and the nature of the problem can be indicated in a note to the order. The status of the order viewed by the buyer is changed to “pending order.” In step 454 it is determined whether the problem encountered in step 452 was resolved.

If the problem has not been resolved, then in step 456 an administrator marks the order and other orders in the group as cancelled, the credit card of the buyer is charged back for any charges related to the current order and a notice is sent to the buyer via email and the supplier of the order, including any suppliers related to the order. Next, in step 458, the system of the present invention takes credit from the supplier for any charges related to the current order that were charged back to the buyer. If the problem has been resolved in step 454, then step 432 is executed.

In step 436 a report of the order is printed for all items in the order for tracking purposes. In step 438 it is determined whether the order requires assembly. If the order requires assembly, then in step 480 the order is sent for assembly, the order is marked as “assembly in process,” and the status of the order viewed by the buyer is changed to “in assembly.” If the order does not require assembly, then step 440 is executed. In step 482 the item or items are assembled and in step 484 the order is marked as assembled and the status or the order viewed by the buyer is changed to “preparing to ship.”

In step 440, it is determined whether partial orders are allowed to be shipped. If partial orders are allowed to be shipped, then in step 486 a decision is made to ship the order and in step 446 a shipping manifest is created for the order, a courier label for the order is printed, a courier tracking number is stored, the order is marked as shipped and the status of the order viewed by the buyer is changed to “shipped.” In step 448 the order is marked for payment to the sales representative associated with the order. In step 450 an administrator effectuates payment for the ordered goods and stores the payment date, payment method and payment amount.

If partial orders are not allowed to be shipped in step 440, then in step 442 then the order is marked as a consolidating order and the status of the order viewed by the buyer is changed to “preparing to ship.” In step 444, it is determined whether all items of the order have been received. If all items have been received, then step 446 is executed. If all items have not been received, then step 442 is executed once more.

An embodiment of the present invention can be embedded in a computer system. A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

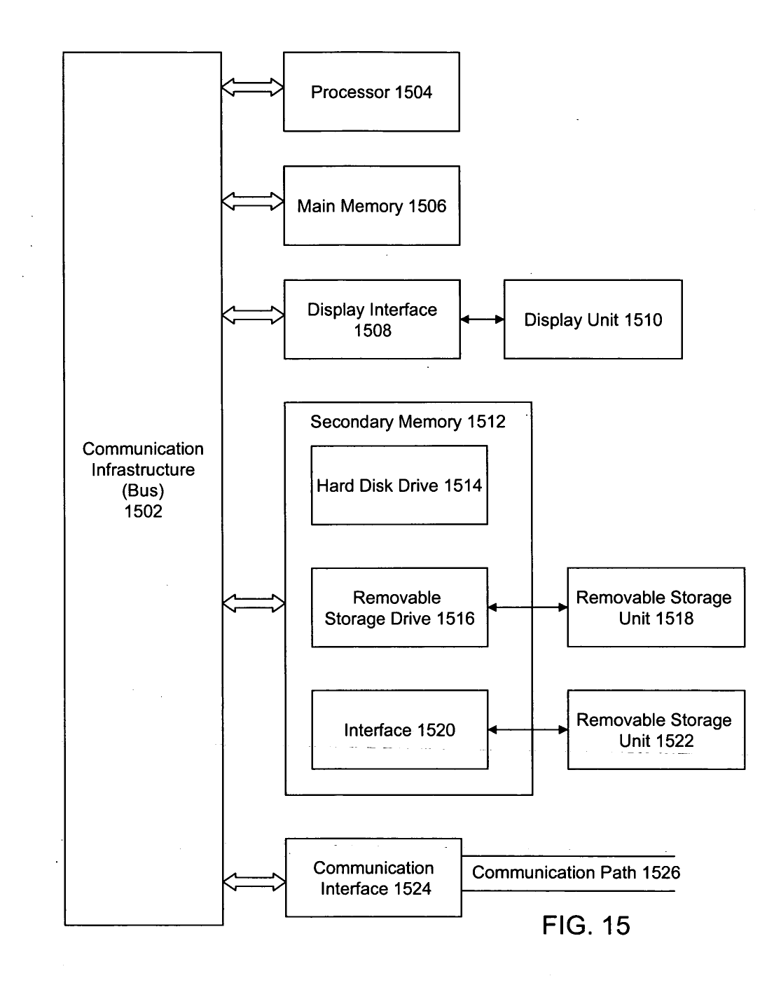

FIG. 15 is a high level block diagram showing an information processing system useful for implementing one embodiment of the present invention. The computer system includes one or more processors, such as processor 1504. The processor 1504 is connected to a communication infrastructure 1502 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 1508 that forwards graphics, text, and other data from the communication infrastructure 1502 (or from a frame buffer not shown) for display on the display unit 1510. The computer system also includes a main memory 1506, preferably random access memory (RAM), and may also include a secondary memory 1512. The secondary memory 1512 may include, for example, a hard disk drive 1514 and/or a removable storage drive 1516, representing a floppy disk drive, a magnetic tape drive, an optical disk drive, etc. The removable storage drive 1516 reads from and/or writes to a removable storage unit 1518 in a manner well known to those having ordinary skill in the art. Removable storage unit 1518, represents a floppy disk, a compact disc, magnetic tape, optical disk, etc. which is read by and written to by removable storage drive 1516. As will be appreciated, the removable storage unit 1518 includes a computer readable medium having stored therein computer software and/or data.

In alternative embodiments, the secondary memory 1512 may include other similar means for allowing computer programs or other instructions to be loaded into the computer system. Such means may include, for example, a removable storage unit 1522 and an interface 1520. Examples of such may include a program cartridge and cartridge interface (such as that found in video game devices), a removable memory chip (such as an EPROM, or PROM) and associated socket, and other removable storage units 1522 and interfaces 1520 which allow software and data to be transferred from the removable storage unit 1522 to the computer system.

The computer system may also include a communications interface 1524. Communications interface 1524 allows software and data to be transferred between the computer system and external devices. Examples of communications interface 1524 may include a modem, a network interface (such as an Ethernet card), a communications port, a PCMCIA slot and card, etc. Software and data transferred via communications interface 1524 are in the form of signals which may be, for example, electronic, electromagnetic, optical, or other signals capable of being received by communications interface 1524. These signals are provided to communications interface 1524 via a communications path (i.e., channel) 1526. This channel 1526 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 1506 and secondary memory 1512, removable storage drive 1516, a hard disk installed in hard disk drive 1514, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, that allow a computer to read such computer readable information.

Computer programs (also called computer control logic) are stored in main memory 1506 and/or secondary memory 1512. Computer programs may also be received via communications interface 1524. Such computer programs, when executed, enable the computer system to perform the features of the present invention as discussed herein. In particular, the computer programs, when executed, enable the processor 1504 to perform the features of the computer system. Accordingly, such computer programs represent controllers of the computer system.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. An information processing system, comprising:
a first interface for receiving from suppliers information relating to a plurality of items of jewelry available for purchase and components related to the plurality of items;
a database configured for storing the information relating to the plurality of items and the components related to the plurality of items;
a second interface for presenting to buyers the information relating to the plurality of items of jewelry and for receiving from buyers a selection of an item of jewelry for purchase;
a search engine for searching the database for information relating to an item of jewelry selected by a buyer and components related to the item of jewelry; and
logic for presenting to the buyer, via the second interface, information associated with components related to an item of jewelry selected by the buyer and options on constructing a jewelry assembly comprising the item of jewelry and components selected by the buyer via the second interface.

2. The information processing system of claim 1, wherein the first interface comprises any one of a graphical user interface and a receiver for receiving transmissions.

3. The information processing system of claim 1, wherein the first interface is a graphical user interface accessible through the web.

4. The information processing system of claim 1, wherein the second interface comprises any one of a graphical user interface and a receiver for receiving transmissions.

5. The information processing system of claim 1, wherein the second interface is a graphical user interface accessible through the web.

6. The information processing system of claim 1, wherein an item of jewelry comprises a necklace, a ring, an earring, a pendant, a bracelet and a watch.

7. The information processing system of claim 6, wherein a component related to an item of jewelry comprises at least one of a setting, a stone, and a side stone.

8. The information processing system of claim 7, wherein a component comprises a plurality of attributes and wherein attributes of a setting include a metal and a setting type, and attributes of a stone and a side stone include shape, color, cut, clarity, gridles, labs, culets, polish symmetry, fluorescent intensity, enhancements, markings, and luster.

9. The information processing system of claim 1, further comprising:
a third interface for receiving payment information from the buyer for purchasing the item of jewelry selected by the buyer.

10. The information processing system of claim 1, wherein the second interface receives from buyers search parameters relating to an item of jewelry for purchase and wherein the search engine searches the database for an item of jewelry that matches the search parameters.

11. The information processing system of claim 1, wherein the logic for presenting to the buyer comprises:
logic for determining, based on dimensions of the item of jewelry selected by the buyer, components that fit the item of jewelry selected by the buyer and presenting to the buyer, via the second interface, information associated with the components that fit the item of jewelry selected by the buyer and options on constructing a jewelry assembly comprising the item of jewelry and components selected by the buyer via the second interface.

12. A method for facilitating jewelry transactions, comprising:
receiving from suppliers, via a first interface, information relating to a plurality of items of jewelry available for purchase and components related to the plurality of items;
storing in a database the information relating to the plurality of items and the components related to the plurality of items;
presenting to buyers, via a second interface, the information relating to the plurality of items of jewelry and for receiving from buyers a selection of an item of jewelry for purchase;
searching the database for information relating to an item of jewelry selected by a buyer and components related to the item of jewelry; and
presenting to the buyer, via the second interface, information associated with components related to an item of jewelry selected by the buyer and options on constructing a jewelry assembly comprising the item of jewelry and components selected by the buyer via the second interface.

13. The method of claim 12, wherein the step of receiving comprises:
receiving from suppliers, via a first interface comprising any one of a graphical user interface and a receiver for receiving transmissions, information relating to a plurality of items of jewelry available for purchase and components related to the plurality of items.

14. The method of claim 12, wherein the step of receiving comprises:
receiving from suppliers, via a first interface accessible through the web, information relating to a plurality of items of jewelry available for purchase and components related to the plurality of items.

15. The method of claim 12, further comprising:
receiving from buyers, via the second interface, search parameters relating to an item of jewelry for purchase and searching the database for an item of jewelry that matches the search parameters.

16. The method of claim 12, wherein the step of presenting comprises:
determining, based on dimensions of the item of jewelry selected by the buyer, components that fit the item of jewelry selected by the buyer and presenting to the buyer, via the second interface, information associated with the components that fit the item of jewelry selected by the buyer and options on constructing a jewelry assembly comprising the item of jewelry and components selected by the buyer via the second interface.

17. A computer readable medium including computer instructions for facilitating jewelry transactions, the computer instructions including instructions for:
receiving from suppliers, via a first interface, information relating to a plurality of items of jewelry available for purchase and components related to the plurality of items;
storing in a database the information relating to the plurality of items and the components related to the plurality of items;
presenting to buyers, via a second interface, the information relating to the plurality of items of jewelry and for receiving from buyers a selection of an item of jewelry for purchase;
searching the database for information relating to an item of jewelry selected by a buyer and components related to the item of jewelry; and
presenting to the buyer, via the second interface, information associated with components related to an item of jewelry selected by the buyer and options on constructing a jewelry assembly comprising the item of jewelry and components selected by the buyer via the second interface.

18. The computer readable medium of claim 17, wherein the instructions for receiving comprise instructions for:
receiving from suppliers, via a first interface comprising any one of a graphical user interface and a receiver for receiving transmissions, information relating to a plurality of items of jewelry available for purchase and components related to the plurality of items.

19. The computer readable medium of claim 17, wherein the instructions for receiving comprise instructions for:
receiving from suppliers, via a first interface accessible through the web, information relating to a plurality of items of jewelry available for purchase and components related to the plurality of items.

20. The computer readable medium of claim 17, further comprising instructions for:
receiving from buyers, via the second interface, search parameters relating to an item of jewelry for purchase and searching the database for an item of jewelry that matches the search parameters.
